(19) United States
(12) Patent Application Publication
(10) Pub. No.: US 2005/0231372 A1
(43) Pub. Date: Oct. 20, 2005

(54) Device for remote identification of parts

(75) Inventor: Richard Parsons, Mesa, AZ (US)

Correspondence Address: PILLSBURY WINTHROP SHAW PITTMAN, LLP, P.O. BOX 10500, MCLEAN, VA, 22102, US

(73) Assignee: Tokyo Electron Limited, Tokyo (JP)

(21) Appl. No.: 10/812,083

(22) Filed: Mar. 30, 2004

(51) Int. Cl. G08B 13/14

(52) U.S. Cl. 340/572.8; 235/385; 340/572.5

(57) ABSTRACT

A method and apparatus for encoding a part in a semiconductor tool with a unique radio frequency response to an external radio frequency excitation. The method and apparatus remotely read the identifying radio frequency characteristic of a component of a semiconductor process tool.

### FIELD OF THE INVENTION

The invention relates to methods and apparatus for encoding a part in a semiconductor tool.

### BRIEF DESCRIPTION OF THE DRAWINGS

FIG. 1 illustrates a schematic block diagram of a plasma processing system according to an embodiment of the present invention;

FIG. 2 presents an expanded cross-sectional view of a portion of one type of a plasma processing system;

FIG. 3 presents an expanded cross-sectional view of a portion of another type of a plasma processing system;

FIG. 4 presents an expanded cross-sectional view of a portion of a third type of a plasma processing system;

FIG. 5 presents an expanded cross-sectional view of a portion of a fourth type of a plasma processing system;

FIG. 6 is a schematic diagram of the radio frequency excitation means according to an embodiment of the present invention;

FIG. 7 presents the radio frequency response of the plasma processing system of FIG. 1 with embedded radio frequency encoding devices according to an embodiment of the present invention;

FIG. 8 represents the radio frequency response to external excitation of the plasma processing system shown in FIG. 1;

FIG. 9 presents the inductor capacitor configuration according to the presently preferred embodiment of the invention; and

FIG. 10 presents a possible placement of the inductor capacitor configuration in a representative component of the plasma processing system of FIG. 1.

### DETAILED DESCRIPTION OF SEVERAL EMBODIMENTS

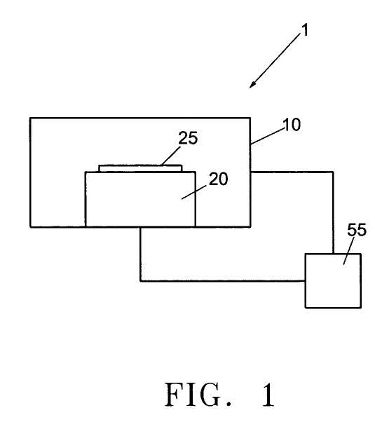

According to an embodiment of the present invention, a material processing system 1 is depicted in FIG. 1 that includes a process tool 10 having a substrate holder 20 and a substrate 25 supported thereon.

In the illustrated embodiment depicted in FIG. 1, the material processing system 1 can include an etch chamber. For example, the etch chamber can facilitate dry plasma etching, or, alternatively, dry non-plasma etching. Alternately, the material processing system 1 includes a photoresist coating chamber such as a heating/cooling module in a photoresist spin coating system that may be utilized for post-adhesion bake (PAB) or post-exposure bake (PEB), etc.; a photoresist patterning chamber such as an ultraviolet (UV) lithography system; a dielectric coating chamber such as a spin-on-glass (SOG) or spin-on-dielectric (SOD) system; a deposition chamber such as a chemical vapor deposition (CVD) system or a physical vapor deposition (PVD) system; or a rapid thermal processing (RTP) chamber such as a RTP system for thermal annealing.

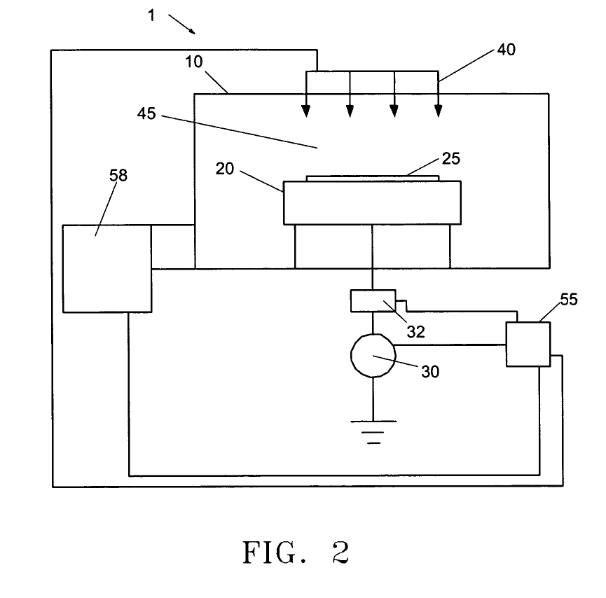

According to the illustrated embodiment depicted in FIG. 2, the material processing system 1 includes process tool 10, substrate holder 20, upon which a substrate 25 to be processed is affixed, gas injection system 40, and vacuum pumping system 58. Substrate 25 can be, for example, a semiconductor substrate, a wafer, or a liquid crystal display (LCD). Process tool 10 can be, for example, configured to facilitate the generation of plasma in processing region 45 adjacent a surface of substrate 25, where plasma is formed via collisions between heated electrons and an ionizable gas. An ionizable gas or mixture of gases is introduced via gas injection system 40, and the process pressure is adjusted. Plasma can be utilized to create materials specific to a predetermined materials process, and to aid either the deposition of material to substrate 25 or the removal of material from the exposed surfaces of substrate 25.

As shown in FIG. 2, substrate holder 20 can include an electrode through which RF power is coupled to plasma in processing region 45. For example, substrate holder 20 can be electrically biased at an RF voltage via the transmission of RF power from RF generator 30 through impedance match network 32 to substrate holder 20. The RF bias can serve to heat electrons to form and maintain plasma. In this configuration, the system can operate as a reactive ion etch (RIE) reactor, where the chamber and upper gas injection electrode serve as ground surfaces. A typical frequency for the RF bias can range from about 1 MHz to about 100 MHz and can be about 13.6 MHz.

Alternately, RF power can be applied to the substrate holder electrode at multiple frequencies. Furthermore, impedance match network 32 serves to maximize the transfer of RF power to plasma in processing chamber 10 by minimizing the reflected power. Various match network topologies (e.g., L-type, B-type, T-type, etc.) and automatic control methods can be utilized.

With continuing reference to FIG. 2, process gas can be, for example, introduced to processing region 45 through gas injection system 40. Process gas can, for example, include a mixture of gases such as Ar, Kr, Ne, He, CF₄, C₄F₈, C₄F₆, C₅F₈, O₂, H₂, N₂, Cl₂, SF₆, HBr, CO, HF, NH₃, etc. Gas injection system 40 includes a showerhead, where process gas is supplied from a gas delivery system (not shown) to the processing region 45 through a gas injection plenum (not shown), a series of baffle plates (not shown) and a multi-orifice showerhead gas injection plate (not shown).

Vacuum pump system 58 can, for example, include a turbo-molecular vacuum pump (TMP) capable of a pumping speed up to about 5000 liters per second (and greater) and a gate valve for throttling the chamber pressure. In conventional plasma processing devices utilized for dry plasma etch, a about 1000 to about 3000 liter per second TMP is generally employed. TMPs are useful for low pressure processing, typically less than about 50 mTorr. At higher pressures, the TMP pumping speed falls off dramatically. For high pressure processing (i.e., greater than about 100 mTorr), a mechanical booster pump and dry roughing pump can be used. Furthermore, a device for monitoring chamber pressure (not shown) is coupled to the process chamber 16. The pressure measuring device can be, for example, a Type 628B Baratron absolute capacitance manometer commercially available from MKS Instruments, Inc. (Andover, Mass.).

Controller 55 can be used to control vacuum pumping system 58, gas injection system 40, RF generator 30 and match network 32.

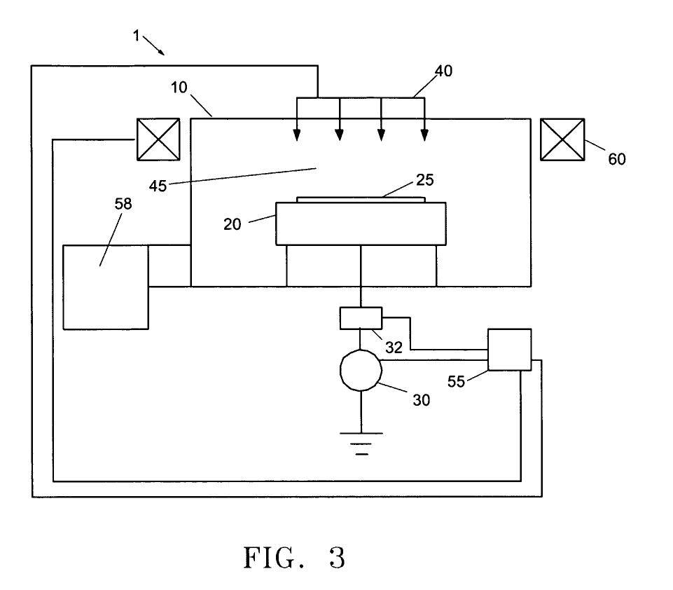

As shown in FIG. 3, material processing system 1 can include a magnetic field system 60. For example, the magnetic field system 60 can generate a stationary, or either a mechanically or electrically rotating DC or AC magnetic field in order to potentially increase plasma density and/or improve material processing uniformity. Moreover, controller 55 can be coupled to magnetic field system 60 in order to regulate the field strength or speed of rotation.

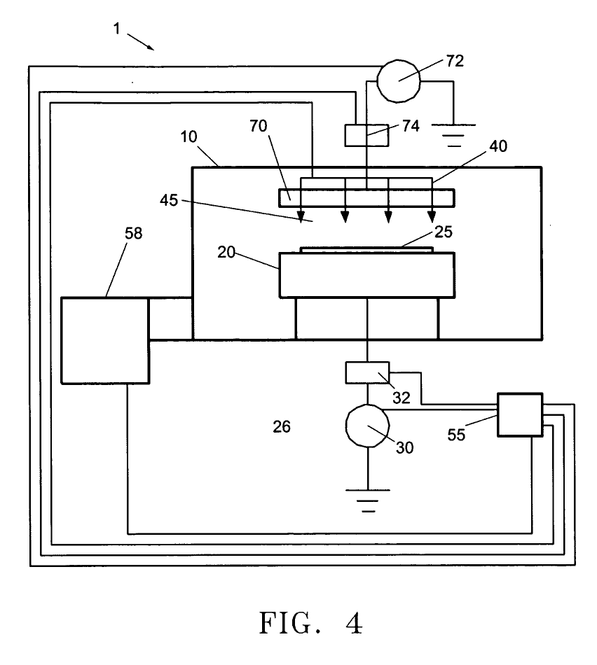

As shown in FIG. 4, the material processing system can include an upper electrode 70. For example, RF power can be coupled from RF generator 72 through impedance match network 74 to upper electrode 70. A frequency for the application of RF power to the upper electrode preferably ranges from about 10 MHz to about 200 MHz and can be about 60 MHz. Additionally, a frequency for the application of power to the lower electrode can range from about 0.1 MHz to about 30 MHz and can be about 2 MHz. Moreover, controller 55 can be coupled to RF generator 72 and impedance match network 74 in order to control the application of RF power to upper electrode 70.

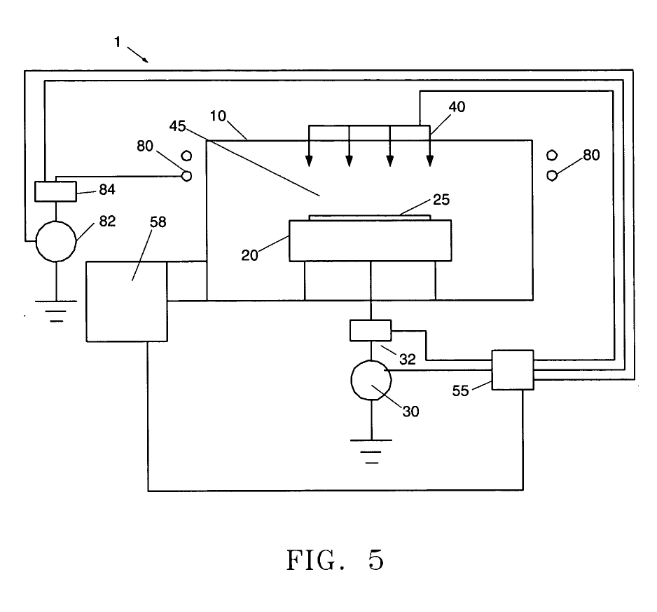

As shown in FIG. 5, the material processing system of FIG. 1 can include an inductive coil 80. For example, RF power can be coupled from RF generator 82 through impedance match network 84 to inductive coil 80, and RF power can be inductively coupled from inductive coil 80 through dielectric window (not shown) to plasma processing region 45. A frequency for the application of RF power to the inductive coil 80 can range from about 10 MHz to about 100 MHz and can be about 13.6 MHz. Similarly, a frequency for the application of power to the chuck electrode can range from about 0.1 MHz to about 30 MHz and can be about 13.56 MHz. In addition, a slotted Faraday shield (not shown) can be employed to reduce capacitive coupling between the inductive coil 80 and plasma. Moreover, controller 55 can be coupled to RF generator 82 and impedance match network 84 in order to control the application of power to inductive coil 80. In an alternate embodiment, inductive coil 80 can be a “spiral” coil or “pancake” coil in communication with the plasma processing region 45 from above as in a transformer coupled plasma (TCP) reactor.

Alternately, the plasma can be formed using electron cyclotron resonance (ECR). In yet another embodiment, the plasma is formed from the launching of a Helicon wave. In yet another embodiment, the plasma is formed from a propagating surface wave.

Each of the systems of FIGS. 1-5 are comprised of many individual parts and sub assemblies. It is desirable to identify these parts and sub assemblies without the need to disassemble and visually inspect each part and/or sub assembly. One embodiment of this invention places a resonant electrical circuit embedded in or attached to individual parts and sub assemblies which can then be remotely identified by a radio frequency (RF) procedure.

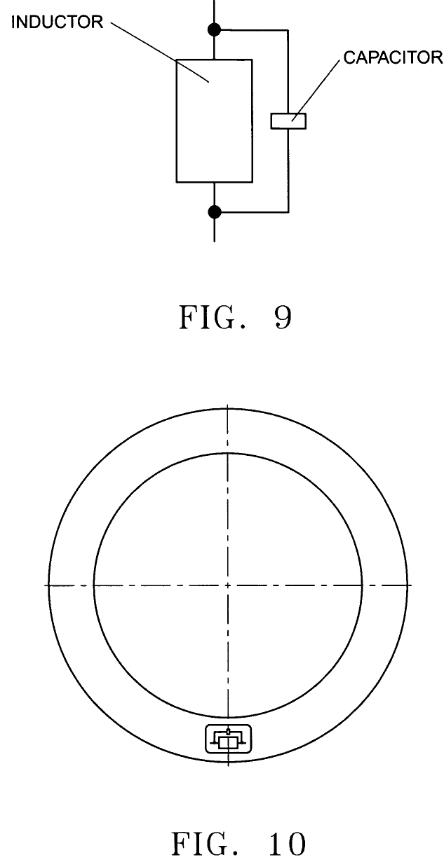

This RF procedure can be based upon Inductor, Capacitor (LC) resonant circuits adjusted to defined resonant frequencies. In one embodiment, these LC resonant circuits, hereinafter referred to as Identification Tags, can be inductive resistors made of wound enameled copper wire with a soldered on capacitor as illustrated in FIG. 9. This Identification Tag can then be embedded in a recess in the part or sub assembly to be identified, as illustrated in the ceramic focus ring of FIG. 10. In another embodiment, the Identification Tag can employ coils etched in foils wherein the capacitive element can be formed by foils separated by an insulating layer. These Identification Tags, in the form of labels, can be attached to a part or sub assembly by means of an adhesive or by a mechanical attachment means such as a screw or rivet. Any parts or assemblies of the material processing system 1 can be identified with the Identification Tag, such as, for example, consumable parts. The parts or assemblies can have Identification Tags to identify proper parts for each model of processing system and to identify genuine parts.

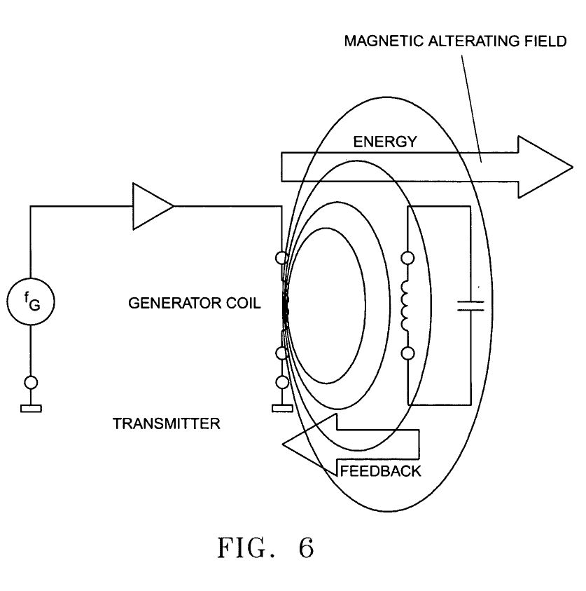

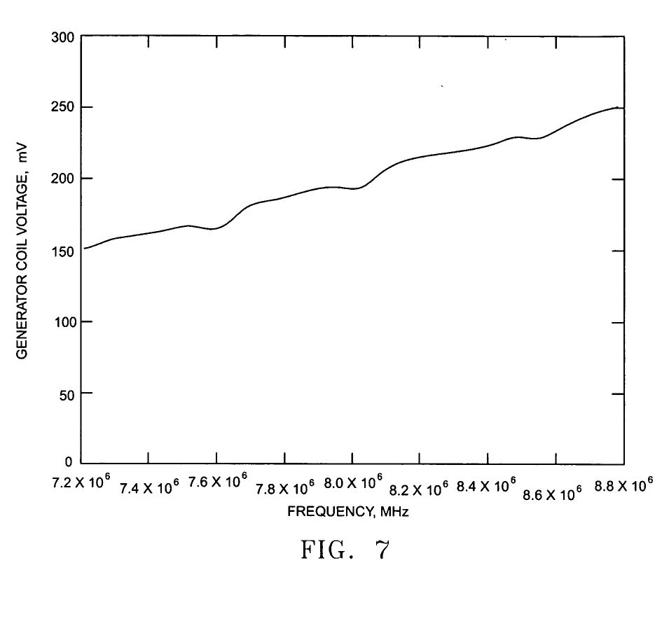

Each part or sub assembly to be identified receives an Identification Tag tuned to a unique frequency. These tuned circuits can uniquely identify each part or sub assembly to which they are attached. The reader, illustrated in FIG. 6, generates a magnetic alternating field in the radio frequency range. The Identification Tags in the vicinity of the magnetic alternating field will extract energy from the alternating field, preferentially at the resonant frequency of the Identification Tag, resulting in a weakening of the measurable magnetic field strength at that frequency and a small change in the voltage developed across the coil of the reader transmitter. FIG. 7 is exemplary of the voltage developed across the coil of the reader in a system with three Identification Tags embedded or otherwise attached to parts or subassemblies of a semiconductor process tool. Each different kind of part or assembly can receive a unique identifier, or each individual part can receive a unique identifier.

The number of uniquely tuned Identification Tags in a system is limited only by available bandwidth and Quality factor, Q, of the Identification Tag. The Q of the Identification Tag is dependent upon the resistance of the LC circuit and the magnetic coupling of the inductor. Construction of Identification Tags from discrete components is typically limited to resonant frequencies between about 1 MHz and about 300 MHz. Below about 1 MHz the physical size of capacitors and inductors become prohibitively large. Above about 300 MHz, the physical size inductors and capacitors become prohibitively small. The Q of the Identification Tag determines the range of frequencies to which the Identification Tag will respond. Spacing in the frequency domain can be about 20% of the design frequency. For example, an Identification Tag designed to operate at about 30 MHz may be used in conjunction with Identification Tags designed to operate at about 24 MHz and about 36 MHz. Identification Tag with improved Q factors can be used to reduce frequency spacing.

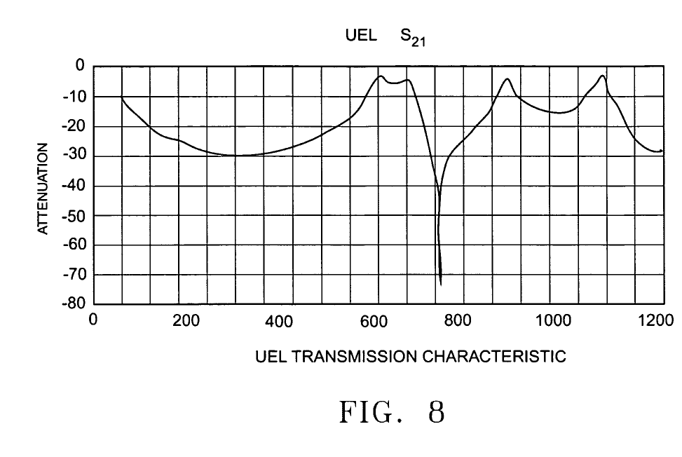

Identification Tag frequency selection is also determined by the response characteristics of the semiconductor process tool in which the parts to be identified are placed. In order to determine the response characteristics of the process tool, a swept RF signal is injected into the process tool and the resultant RF response is measured. For example, an Agilent ESA-E series spectrum analyzer with tracking generator can be used to inject a signal at an electrode, 20 of FIG. 4, and measured at an opposite electrode, 70 of FIG. 4. FIG. 8 illustrates the frequency response of a process tool indicates a number of frequencies at which RF response is greatly attenuated, making those attenuated frequencies undesirable for Identification Tag selection. Alternately, conventional RF modeling techniques may be employed to determine the frequency response of the structure.

Although only several embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A method of attaching an identification tag to parts or sub assemblies of a semiconductor process tool, comprising:
forming a shallow cup in the part or sub assembly of the semiconductor processing tool; and
placing the identification tag in the cup;

2. A method of employing an identification tag with parts or sub assemblies of a semiconductor process tool, comprising:
attaching the identification tag to the part or sub assembly of the semiconductor processing tool.

3. The method of claim 2, wherein the attaching includes adhering the identification tag to the part or sub assembly with adhesive.

4. The method of claim 2, wherein the attaching includes affixing the identification tag by means of a mechanical fastener.

5. A method of detecting the presence or absence of an identification tag at a location using a sensing coil, the tag being responsive to radio frequency energy, comprising:
applying a swept radio frequency signal to the coil; and
determining if a dip in coil voltage is present.

6. A method of detecting the presence or absence of a plurality of identification tags responsive to radio frequency energy, comprising:
applying a swept radio frequency signal to the sensing coil; and
associating a dip in sensing coil voltage with an identification tag;
wherein each of the plurality of identification tags is constructed to be resonant at different frequencies.

7. A method of identifying a part or assembly in a semiconductor processing tool, the part having an identification tag attached, the tag being responsive to radio frequency energy, comprising:
applying a swept radio frequency signal to the coil;
determining a frequency at which a dip in coil voltage is present; and
determining the presence or absence of the part or assembly from the frequency at which the dip occurs.

8. A method of identifying parts or assemblies in a semiconductor processing tool, the parts each having an identification tag attached, each identification tag be responsive to radio frequency energy, comprising:
applying a swept radio frequency signal to the sensing coil;
associating a dip in sensing coil voltage associated with each identification tag;
wherein each of the plurality of identification tags is constructed to be resonant at different frequencies, and
determining the presence or absence of the parts or assemblies from the frequencies at which the dips occur.

9. An assembly comprising:
a part or assembly of a semiconductor processing tool; and
an identification tag attached to the part or assembly, the tag being responsive to radio frequency energy of a particular frequency.

10. An semiconductor processing tool comprising:
a processing chamber;
a plurality of parts or assemblies attached to or disposed in the processing chamber; and
an identification tag attached to each of the parts or assemblies, each identification tag being responsive to radio frequency energy of a different frequency.
